(19) United States
(12) Patent Application Publication
(10) Pub. No.: US 2007/0240176 A1
(43) Pub. Date: Oct. 11, 2007

(54) Recording and reproducing device

(75) Inventor: Kazuhiro Watanabe, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/730,767

(22) Filed: Apr. 4, 2007

(30) Foreign Application Priority Data
Apr. 5, 2006 (JP) 2006-104530

(51) Int. Cl. G11B 7/00

(52) U.S. Cl. 720/692

(57) ABSTRACT

The present invention reduces contact noise between a turntable and a clamper without increasing the number of components. Spring pieces are formed by forming slit grooves in the corners of a support plate. When the support plate is secured by screws to bosses of a frame, the spring pieces formed in the four corners of the support plate are elastically contacted with the frame, with the support plate slightly floated from the frame. Thereby, vibration transmitted to the support plate from the clamper is absorbed by the spring pieces, thus suppressing noise caused by the vibration transmitted to the support plate.

The present application is based on and claims priority of Japanese patent application No. 2006-104530 filed on Apr. 5, 2006, the entire contents of which are hereby incorporated by reference.

### BACKGROUND OF THE INVENTION

1. Field of the Invention

The present invention relates to a recording and reproducing device for rotating a disk-shaped recording medium (hereinafter referred to simply as a disk) grasped by a turntable and a clamper, and more particularly, relates to a recording and reproducing device capable of suppressing contact noise between the clamper and the turntable as much as possible.

2. Description of the Related Art

In general, a recording and reproducing device rotates a recording medium such as a CD (Compact Disk) or a DVD (Digital Versatile Disk), applies laser light from a pickup unit to the recording surface of the recording medium, and receives by the pickup unit the laser light reflected from the recording surface of the recording medium, thereby reading and reproducing information recorded on the recording medium or writing and recording information on the recording medium. When the recording and reproducing device records or reproduces information to/from a disk, the disk is grasped by a turntable provided at the recording surface of the disk that is carried in the device by a carrying mechanism such as a tray and a roller and a clamper provided at the label surface of the disk, and the disk rotates together with the clamper and the turntable by the driving force of a motor coupled to the turntable. By applying laser light from the pickup unit to the recording surface of the rotating disk and receiving at the pickup unit the reflected light, recording or reproducing is performed on the disk. Main components such as the turntable coupled to the motor and the pickup unit are assembled on a chassis into a single unit as a traverse unit, which is mounted on a frame. In this case, the traverse unit is joined at one end to the frame through a buffer member, and joined at the other end to a slidable cam plate. The cam plate slides in conjunction with the carrying mechanism such as the tray and the roller for carrying the disk. When the disk is carried to a predetermined position in the device by the carrying mechanism, the cam plate slides in conjunction with the carrying mechanism, and the other end of the traverse unit joined to the cam plate is raised rotationally, with the one end joined to the frame acting as a fulcrum. Thereby, the turntable is fitted into an opening formed in approximately the center portion of the disk at the predetermined position and is further raised. A clamper provided at a position opposite to the turntable presses the disk from the label surface side to grasp it.

The turntable and the clamper grasp the disk, for example, with a structure in which a magnet is mounted in the clamper and a magnetic material is mounted on the surface of the turntable opposite to the clamper so as to generate an attractive force between the magnet and the magnetic material. In the case where a tray that can linearly travel between the outside and the inside of the device is used as a carrying mechanism for the disk, when the tray is carried in even without a disk thereon, the traverse unit moves up and the turntable is stuck to the clamper without a disk by magnetic force. When the turntable is thus stuck to the clamper without a disk so that the turntable directly contacts the clamper, contact noise occurs. The number of revolutions of the turntable at the time of reading and reproducing information recorded on the disk is different from the number of revolutions of the turntable at the time of writing and recording information on the disk. More specifically, the number of revolutions of the turntable at the time of reproducing is about 3,000 rpm, whereas the number of revolutions of the turntable at the time of recording is about 9,000 rpm. Therefore, in the case where a support plate for suspending the clamper is made of metal in order to increase stiffness for the high-speed rotation of the turntable at the time of recording, when the turntable directly contacts the clamper, contact noise is transmitted to the metallic support plate and amplified. As a countermeasure against the contact noise between the turntable and the clamper, for example, Japanese Unexamined Patent Application Publication No. 2003-223776 (patent document 1) describes a structure in which a rubber ring as a means for suppressing noise and vibration caused by a collision of a clamper (called a disk clamper in patent document 1) with a disk and a support plate (called a clamper plate in patent document 1) is interposed between the clamper and the disk or between the disk clamper and the support plate. Further, Japanese Unexamined Patent Application Publication No. 2003-217203 (patent document 2) discloses a disk drive in which a support plate (called a clamper supporting member in patent document 2) is made of a vibration-clamping steel sheet so as to suppress vibration resulting from the rotation of a disk, thereby suppressing noise.

As described above, in the case where the support plate for suspending the clamper is made of metal to increase the stiffness, when the turntable directly contacts the clamper, contact noise is transmitted to the metallic support plate and amplified. If a structure in which a rubber ring is interposed between the clamper and the support plate to reduce the contact noise between the turntable and the clamper as described in patent document 1 is used as a countermeasure against the contact noise, it takes a lot of time and labor to mount the rubber ring and also it is necessary to form the rubber ring separately, which brings about an additional manufacturing process and an increase in cost. In the disk drive disclosed in patent document 2, the support plate for suspending the clamper is molded of a special material such as the vibration-clamping steel sheet in order to suppress the vibration resulting from the rotation of the disk, which also causes an increase in cost.

### SUMMARY OF THE INVENTION

The present invention has been made in view of the above circumstance, and it is an object of the invention to provide a recording and reproducing device capable of reducing contact noise between a turntable and a clamper with a low-cost structure without increasing the number of components.

A first aspect of the invention relates to a recording and reproducing device including a carrying mechanism for carrying a disk-shaped recording medium, a frame for mounting the carrying mechanism, a pickup unit for scanning the recording medium carried in the frame, a turntable for rotating the recording medium, a clamper which is provided at a position opposite to the turntable, and a support plate which is installed between side walls of the frame to secure the clamper, wherein an elastic portion having flexibility is formed on at least one of the support plate and the frame, and the elastic portion is elastically contacted with the other of the support plate and the frame, with the support plate slightly floated from the top ends of the side walls.

According to the first aspect of the invention, when the carrying mechanism is inserted into the frame, the traverse unit moves up, and the turn table collides with the clamper. Vibration transmitted to the support plate from the clamper is absorbed by the elastic portion, thus making it difficult for the vibration to be transmitted to the whole of the support plate. Therefore, it is possible to suppress the collision noise between the turntable and the clamper as much as possible.

A second aspect of the invention relates to the recording and reproducing device according to the first aspect, wherein slit grooves are formed at both sides of the support plate, thereby forming spring pieces as elastic portions, and the spring pieces are elastically contacted with the frame.

According to the second aspect of the invention, vibration transmitted to the support plate from the clamper is absorbed by the spring pieces of the support plate, thus making it difficult for the vibration to be transmitted to the whole of the support plate. Therefore, it is possible to suppress the collision noise between the turntable and the clamper as much as possible.

A third aspect of the invention relates to the recording and reproducing device according to the first aspect, wherein the frame is integrally molded of a synthetic resin, and resin springs as elastic portions are integrally molded at the side walls of the frame and elastically contacted with the support plate.

According to the third aspect of the invention, vibration transmitted to the support plate from the clamper is absorbed by the resin springs formed on the frame, thus making it difficult for the vibration to be transmitted to the whole of the support plate. Therefore, it is possible to suppress the collision noise between the turntable and the clamper as much as possible.

A fourth aspect of the invention relates to a recording and reproducing device including a carrying mechanism for carrying a disk-shaped recording medium, a frame for mounting the carrying mechanism, a pickup unit for scanning the recording medium carried in the frame, a turntable for rotating the recording medium, a clamper which is provided at a position opposite to the turntable, and a support plate which is installed between side walls of the frame to secure the clamper, wherein slits are formed at both sides of the support plate, thereby forming mounting pieces having flexibility, and the mounting pieces are secured to the side walls of the frame.

According to the fourth aspect of the invention, vibration transmitted to the support plate from the clamper is absorbed by the mounting pieces of the support plate, thus making it difficult for the vibration to be transmitted to the whole of the support plate. Therefore, it is possible to suppress the collision noise between the turntable and the clamper as much as possible. Further, since tone quality caused by vibration transmitted to the support plate varies with the length of the slits for forming the mounting pieces, it is possible to eliminate grating noise by adjusting the length of the slits.

### BRIEF DESCRIPTION OF THE DRAWINGS

An embodiment of the present invention will be described in detail based on the following figures, wherein:

FIG. 1 is a perspective view of a disk device according to a first embodiment of the present invention;

FIG. 2 is a plan view of the disk device according to the first embodiment;

FIG. 3 is a cross-sectional view taken along line A-A of FIG. 2;

FIG. 4 is a perspective view with a cross section taken along line A-A of FIG. 2;

FIG. 5 is a sectional view of the disk device according to the first embodiment;

FIG. 6 is a perspective view of a disk device according to a second embodiment of the invention;

FIG. 7 is a plan view of the disk device according to the second embodiment;

FIG. 8 is a side view of the disk device according to the second embodiment;

FIG. 9 is a cross-sectional view taken along line B-B of FIG. 7;

FIG. 10 is a perspective view with a cross section taken along line B-B of FIG. 7;

FIG. 11 is a perspective view of a disk device according to a third embodiment of the invention; and

FIG. 12 is a plan view of the disk device according to the third embodiment.

### DESCRIPTION OF THE PREFERRED EMBODIMENTS

As specific embodiments of a recording and reproducing device (hereinafter referred to as a disk device) according to the present invention, tray-type disk devices will be described with reference to the attached drawings. The embodiments below are merely examples for implementing the invention and not intend to limit the invention.

### First Embodiment

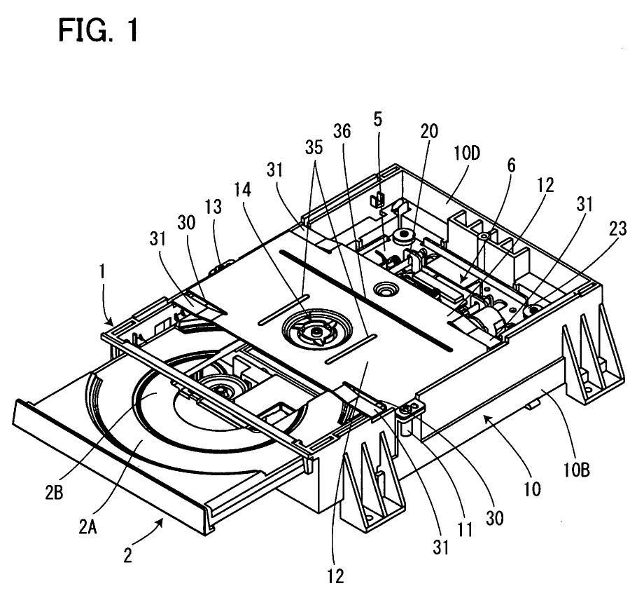

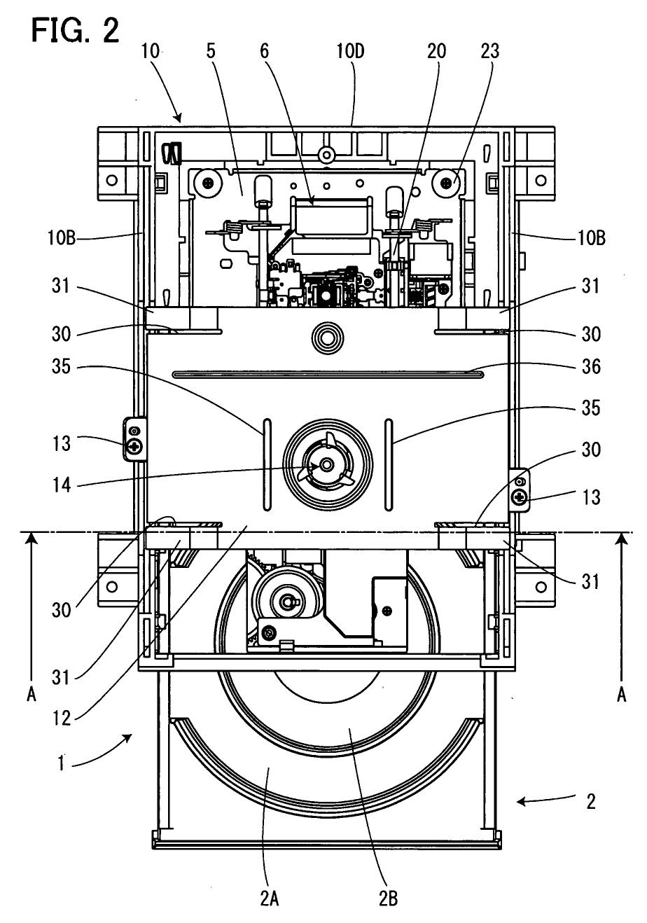

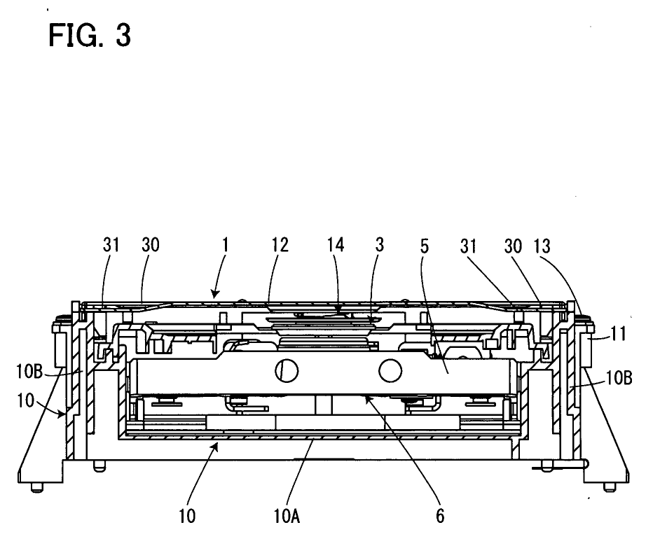

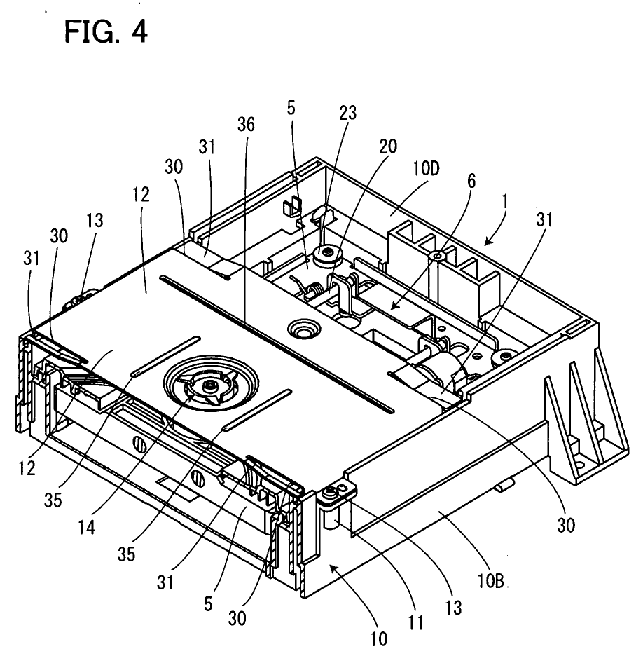

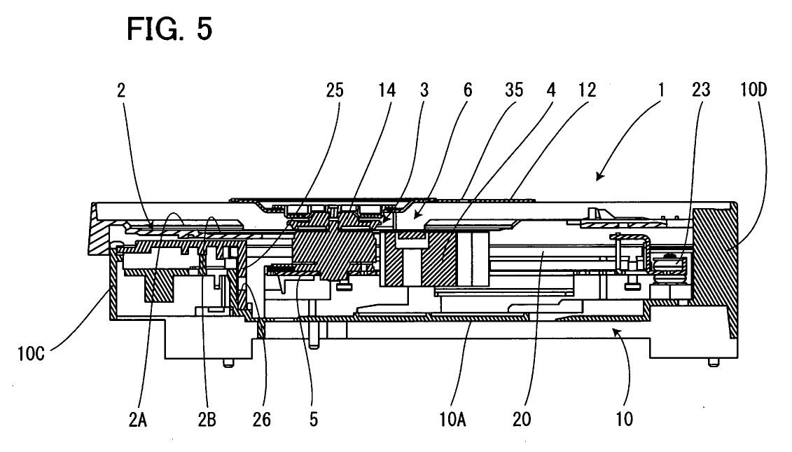

FIGS. 1 to 5 are illustrations showing a disk device according to a first embodiment of the invention. FIG. 1 is a perspective view of the disk device, FIG. 2 is a plan view of the disk device, FIG. 3 is a cross-sectional view taken along line A-A of FIG. 2, FIG. 4 is a perspective view with a cross section taken along line A-A of FIG. 2, and FIG. 5 is a sectional view of the disk device.

As shown in FIGS. 1 to 5, in the disk device 1 according to this embodiment, a tray 2 as a carrying mechanism for carrying in and carrying out a disk (not shown), a turntable 3 for rotationally driving the disk, and a pickup unit 4 provided to be movable in and out in the radial direction of the disk are assembled on a metal chassis 5 into a traverse unit 6, and these main components are mounted on a frame 10 made of a synthetic resin.

The frame 10 is molded of a synthetic resin and formed into a box shape having a bottom. The frame 10 is constructed of a horizontal wall 10A, sidewalls 10B which are integrally formed at the left and right sides of the horizontal wall 10A, and a front wall 10C and a rear wall 10D which are integrally formed at the front and rear of the horizontal wall 10A. Further, a pair of left and right bosses 11 are integrally formed at the front outside of the side walls 10B, and a support plate 12 made of sheet metal is secured to the bosses 11 by screws 13. A clamper 14 facing the turntable 3 is secured to the support plate 12, and the clamper 14 and the turntable 3 grasp a disk to rotationally drive it. The tray 2 travels in a horizontal direction, supported by the horizontal wall 10A of the frame 10.

The tray 2 travels in a horizontal direction, supported by the horizontal wall 10A of the frame 10, and the tray 2 is formed in a flat shape by injection molding or the like. On the top surface of the tray 2, circular stepped recesses 2A and 2B are formed. A disk such as a 12-cm CD can be placed in the upper recess 2A, and a disk such as an 8-cm CD can be placed in the lower recess 2B.

On the metal chassis 5 of the traverse unit 6, a pair of guide shafts 20 for slidably guiding the pickup unit 4, a motor (not shown) for moving in and out the pickup unit 4 in the radial direction of the disk along the guide shafts 20, and a gear mechanism (not shown) for transmitting the motor drive to the pickup unit 4 are mounted. Further, vibration-proof rubbers 23 are mounted on both sides of the rear end of the metal chassis 5, and the rear end of the metal chassis 5 is floatingly attached to the frame 10 through the vibration-proof rubbers 23. Thereby, the metal chassis 5 can be moved vertically at a free end (front end) thereof opposite to the rear end, with the vibration-proof rubbers 23 acting as fulcrums so that the metal chassis 5 is tiltable with respect to the frame 10.

At the free end (front end) of the metal chassis 5, a cam plate 25 which is slid by an interlocking mechanism (not shown) in a lateral direction in conjunction with the operation of the tray 2 is mounted in a slidable manner with respect to the frame 10. The free end of the traverse unit 6 is engaged with a cam groove 26 formed in the cam plate 25. An engagement means for engaging the cam plate 25 and the traverse unit 6 is not limited to a specific one. However, in this embodiment, one end of the guide shaft 20 projecting from the metal chassis 5 is engaged with the cam groove 26 formed in the cam plate 25. Thus, by sliding the cam plate 25 in the lateral direction, the one end of the guide shaft 20 guided by the cam groove 26 moves up and down, so that the free end (front end) of the traverse unit 6 including the metal chassis 5 moves up and down in conjunction with the up-and-down movements of the guide shaft 20, with the vibration-proof rubber 23 acting as a fulcrum.

Thus, when the tray 2 is fully inserted into the frame 10, the cam plate 25 is slid and the one end of the guide shaft 20 engaged with the cam groove 26 is raised so that the free end (front end) of the metal chassis 5 integrated with the guide shaft 20 moves up. Thereby, since the metal chassis 5 is disposed parallel to the horizontal wall 10A of the frame 10 as shown in FIG. 2, the clamper 14 mounted on the support plate 12 and the turntable 3 mounted on the metal chassis 5 grasp a disk, thus making it possible to rotationally drive the disk placed on the tray 2.

Thus, in the case of carrying the disk by the tray 2, when the tray 2 is fully inserted into the frame 10, the cam plate 25 is slid by the interlocking mechanism (not shown) so that the traverse unit 6 moves up. Therefore, if the tray 2 is carried in even without a disk thereon, the traverse unit 6 moves up, and the turntable 3 is stuck to the clamper 14 by magnetic force. Thus, the turntable 3 collides with the clamper 14, and the vibration is transmitted to the metallic support plate 12 to which the clamper 14 is secured, so that the support plate 12 amplifies the noise.

Description will now be made of the structure for suppressing the noise caused by the vibration transmitted to the support plate 12. In the corners of the support plate 12 according to this embodiment, slit grooves 30 are formed, thereby forming spring pieces 31 as elastic portions in the four corners of the support plate 12. When the support plate 12 is secured by the screws 13 to the bosses 11 formed on the side walls 10B of the frame 10, the spring pieces 31 formed in the four corners of the support plate 12 are elastically contacted with the top ends of the side walls 10B, with the support plate 12 slightly floated from the top ends of the side walls 10B. On the support plate 12, a pair of left and right oblong projections 35 are formed at both sides of the clamper 14 mounted on the support plate 12, and a long sideways recess 36 is formed substantially across the full width of the support plate 12, at the rear of the clamper 14.

Thus, in the disk device 1, the support plate 12 is secured to the frame 10 in a state where the spring pieces 31 having flexibility formed in the four corners of the support plate 12 are elastically contacted with the frame 10. Therefore, for example, even if the tray 2 without a disk is carried in the frame 10 and the turntable 3 collides with the clamper 14, the vibration transmitted to the support plate 12 from the clamper 14 is absorbed by the spring pieces 31, thus making it difficult for the vibration to be transmitted to the whole of the support plate 12. Therefore, even if the turntable 3 directly contacts the clamper 14, the noise is not amplified by the support plate 12, thus making it possible to suppress the collision noise as much as possible. Further, it is only necessary to form the spring pieces 31 by forming the slit grooves 30 on the support plate 12, and it is not necessary to mount the rubber ring to the support plate 12 or mold the support plate 12 out of an expensive special material such as a vibration-clamping steel sheet as in the conventional techniques. Therefore, there is no increase in the number of components, and it is possible to simplify the assembling and keep the manufacturing cost low.

### Second Embodiment

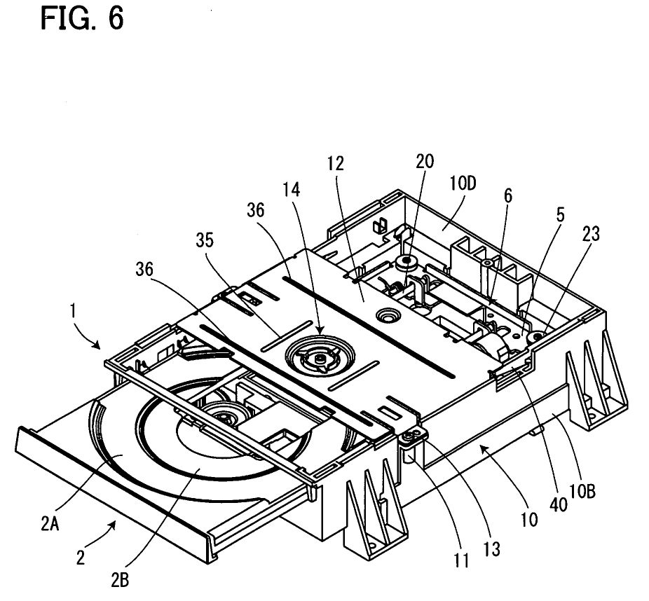

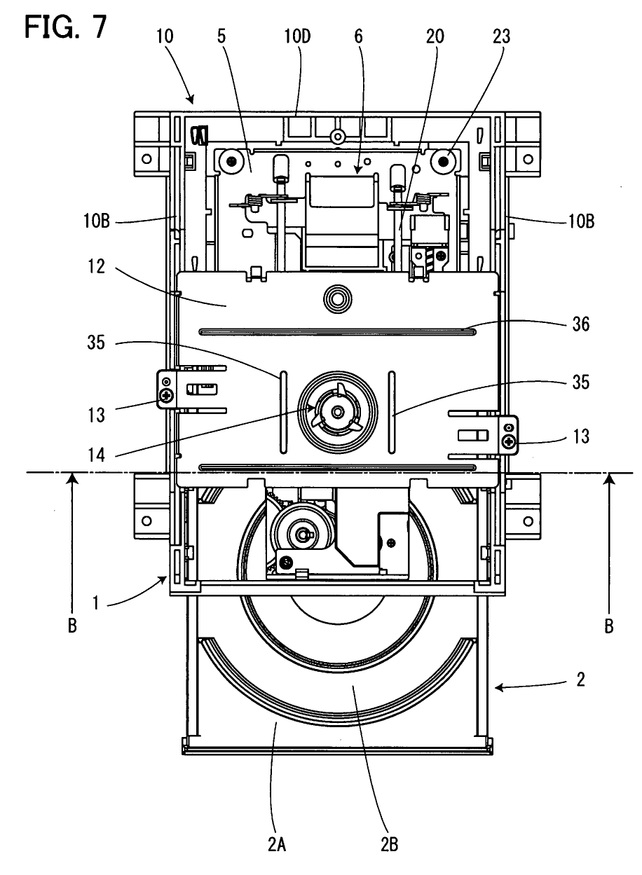

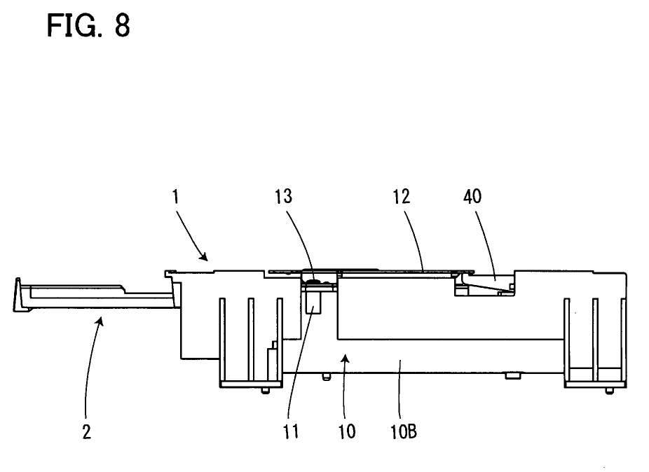

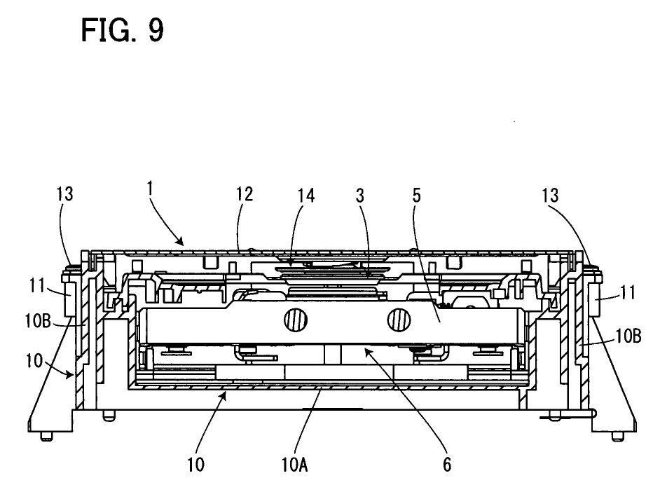

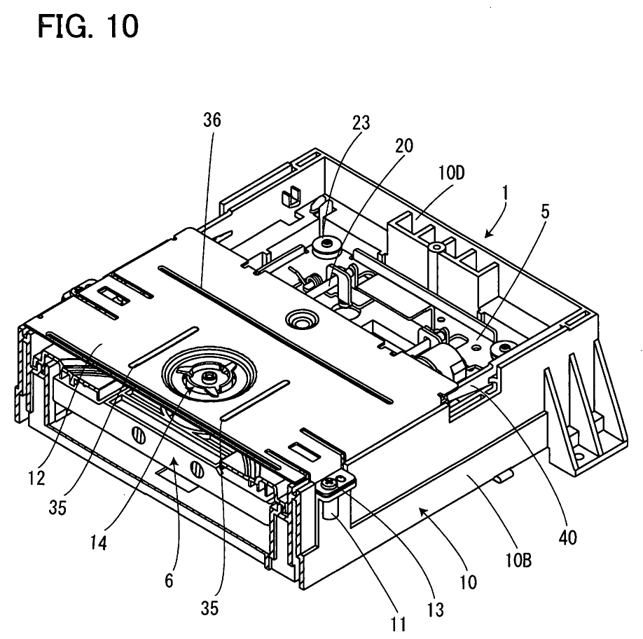

FIGS. 6 to 10 are illustrations showing a disk device according to a second embodiment of the invention. FIG. 6 is a perspective view of the disk device, FIG. 7 is a plan view of the disk device, FIG. 8 is a side view of the disk device, FIG. 9 is a cross-sectional view taken along line B-B of FIG. 7, and FIG. 10 is a perspective view with a cross section taken along line B-B of FIG. 7.

The disk device of this embodiment is substantially the same as that of the first embodiment except the structure of elastic portions. The same portions as those of the first embodiment are denoted by the same reference numerals, and only different portions are described. In the first embodiment, the spring pieces 31 as elastic portions are formed on the support plate 12. However, in this embodiment, resin springs 40 as elastic portions are integrally molded at the side walls 10B of the frame 10 and elastically contacted with the support plate 12. With this structure, when the turntable 3 collides with the clamper 14, the vibration transmitted to the support plate 12 from the clamper 14 is absorbed by the resin springs 40, thus making it difficult for the vibration to be transmitted to the whole of the support plate 12. Therefore, as in the case of the first embodiment, even if the turntable 3 directly contacts the clamper 14, the noise is not amplified by the support plate 12, thus making it possible to suppress the collision noise as much as possible. In addition, it is only necessary to form resin springs 40 on the frame 10, and it is not necessary to mount a vibration-proof member such as a rubber ring to the support plate 12 or mold the support plate 12 out of an expensive special material such as a vibration-clamping steel sheet. Therefore, it is possible to reduce the number of assembly components and simplify the assembling.

### Third Embodiment

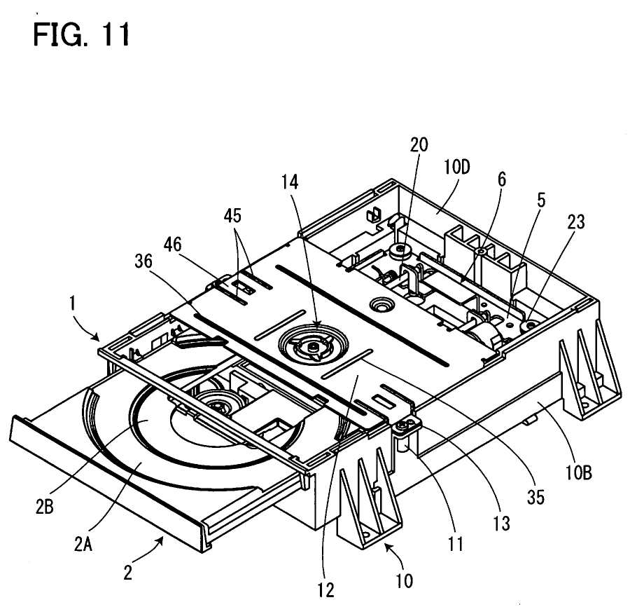

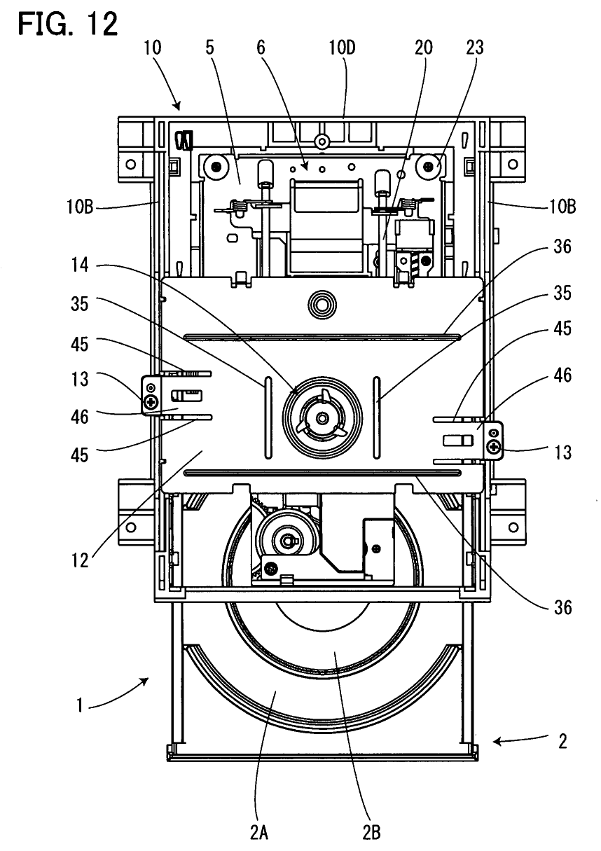

FIGS. 11 and 12 are illustrations showing a disk device according to a third embodiment of the invention. FIG. 11 is a perspective view of the disk device, and FIG. 12 is a plan view of the disk device.

The disk device of this embodiment is substantially the same as those of the foregoing embodiments except the structure of the support plate 12. The same portions as those of the foregoing embodiments are denoted by the same reference numerals, and only different portions are described. In this embodiment, slits 45 are formed at both sides of the support plate 12, thereby forming mounting pieces 46 having flexibility at both sides of the support plate 12. The mounting pieces 46 are secured to the bosses 11 of the frame 10 by the screws 13, with the support plate 12 slightly floated from the frame 10. With this structure, when the turntable 3 collides with the clamper 14, the vibration transmitted to the support plate 12 from the clamper 14 is absorbed by the mounting pieces 46, thus making it difficult for the vibration to be transmitted to the whole of the support plate 12. Therefore, as in the case of the foregoing embodiments, even if the turntable 3 directly contacts the clamper 14, the noise is not amplified by the support plate 12, thus making it possible to suppress the collision noise as much as possible. Further, it has been experimentally confirmed that tone quality caused by vibration transmitted to the support plate 12 varies with the length of the slits 45 for forming the mounting pieces 46 in this embodiment. Therefore, it is possible to eliminate grating noise by adjusting the length of the slits 45 to change the tone quality.

While embodiments of the invention have been described in detail, the invention is not limited thereto and can be modified in various ways without departing from the spirit of the invention. For example, the engagement means for engaging the cam plate and the traverse unit can be selected as appropriate. Further, the basic structure of the disk device is not limited to the above-described embodiments. More specifically, in the embodiments of the invention, the description has been made on the so-called tray-type disk device equipped with the tray as the carrying mechanism for carrying a recording medium; however, the disk device according to the invention is not limited to the tray type and can include a slot-in type disk device into which a recording medium can be directly inserted and a changer-type disk device which can accommodate a plurality of recording media.

It should be understood by those skilled in the art that various modifications, combinations, sub-combinations and alterations may occur depending on design requirements and other factors insofar as they are within the scope of the appended claims or the equivalents thereof.

The effects of the present invention are as follows.

The first aspect of the invention provides a recording and reproducing device including a carrying mechanism for carrying a disk-shaped recording medium, a frame for mounting the carrying mechanism, a pickup unit for scanning the recording medium carried in the frame, a turntable for rotating the recording medium, a clamper which is provided at a position opposite to the turntable, and a support plate which is installed between side walls of the frame to secure the clamper, wherein an elastic portion having flexibility is formed on at least one of the support plate and the frame, and the elastic portion is elastically contacted with the other of the support plate and the frame, with the support plate slightly floated from the top ends of the side walls. Therefore, without mounting a dedicated component for suppressing vibration transmitted to the support plate or molding the support plate out of a special material such as the vibration-clamping steel sheet, it is possible to suppress the contact noise between the turntable and the clamper, and it is possible to reduce the number of components and thereby simplify the assembling.

The second aspect of the invention provides the recording and reproducing device according to the first aspect, wherein slit grooves are formed at both sides of the support plate, thereby forming spring pieces as elastic portions, and the spring pieces are elastically contacted with the frame. Therefore, with a simple structure in which the spring pieces are formed by forming the slit grooves on the support plate, it is possible to suppress the contact noise between the turntable and the clamper.

The third aspect of the invention provides the recording and reproducing device according to the first aspect, wherein the frame is integrally molded of a synthetic resin, and resin springs as elastic portions are integrally molded at the side walls of the frame and elastically contacted with the support plate. Therefore, with a simple structure in which the resin springs are formed on the frame, it is possible to suppress the contact noise between the turntable and the clamper.

The fourth aspect of the invention provides a recording and reproducing device including a carrying mechanism for carrying a disk-shaped recording medium, a frame for mounting the carrying mechanism, a pickup unit for scanning the recording medium carried in the frame, a turntable for rotating the recording medium, a clamper which is provided at a position opposite to the turntable, and a support plate which is installed between side walls of the frame to secure the clamper, wherein slits are formed at both sides of the support plate, thereby forming mounting pieces having flexibility, and the mounting pieces are secured to the side walls of the frame. Therefore, only by forming the slits on the support plate to give a spring effect to the mounting pieces secured to the frame, it is possible to suppress the contact noise between the turntable and the clamper.

What is claimed is:

1. A recording and reproducing device comprising:
a carrying mechanism for carrying a disk-shaped recording medium;
a frame for mounting the carrying mechanism;
a pickup unit for scanning the recording medium carried in the frame;
a turntable for rotating the recording medium;
a clamper which is provided at a position opposite to the turntable; and
a support plate which is installed between side walls of the frame to secure the clamper,
wherein an elastic portion having flexibility is formed on at least one of the support plate and the frame, and the elastic portion is elastically contacted with the other of the support plate and the frame, with the support plate slightly floated from the top ends of the side walls.

2. The recording and reproducing device according to claim 1, wherein slit grooves are formed at both sides of the support plate, thereby forming spring pieces as elastic portions, and the spring pieces are elastically contacted with the frame.

3. The recording and reproducing device according to claim 1, wherein the frame is integrally molded of a synthetic resin, and resin springs as elastic portions are integrally molded at the side walls of the frame and elastically contacted with the support plate.

4. A recording and reproducing device comprising:
a carrying mechanism for carrying a disk-shaped recording medium;
a frame for mounting the carrying mechanism;
a pickup unit for scanning the recording medium carried in the frame;
a turntable for rotating the recording medium;
a clamper which is provided at a position opposite to the turntable; and
a support plate which is installed between side walls of the frame to secure the clamper,
wherein slits are formed at both sides of the support plate, thereby forming mounting pieces having flexibility, and the mounting pieces are secured to the side walls of the frame.
